(19) United States
(12) Patent Application Publication
(10) Pub. No.: US 2007/0297794 A1
(43) Pub. Date: Dec. 27, 2007

(54) PHOTOLITHOGRAPHY SYSTEM AND METHOD

(75) Inventors: Byong-Cheol PARK, Gyeonggi-do (KR); Dong-Hwa SHIN, Gyeonggi-do (KR); Yun-Sik YANG, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/767,324

(22) Filed: Jun. 22, 2007

(30) Foreign Application Priority Data
Jun. 22, 2006 (KR) 2006-56439

(51) Int. Cl. G03D 5/00

(52) U.S. Cl. 396/611

(57) ABSTRACT

A photolithography system includes an application and development module, an exposure module, and an interface module interposed between the first two modules. Bake units for performing a post-exposure bake process are provided to both the application and development module and the interface module. The interface module also includes a buffer unit. An error detected within the application and development module would ordinarily stop operation of the post-exposure bake process in the application and development module. Upon detection of the error, communication between the auxiliary controller controlling the bake unit of the interface module and the exposure controller is made, and a wafer processed at the exposure module undergoes a post-exposure bake process at the bake unit of the interface module, and then is stored in the buffer unit of the interface module.

### CROSS-REFERENCE TO RELATED APPLICATIONS

This U.S. non-provisional patent application claims priority under 35 U.S.C. § 119 of Korean Patent Application No. 2006-56439, filed on Jun. 22, 2006, the entire contents of which are hereby incorporated by reference.

### BACKGROUND OF THE INVENTION

The present invention disclosed herein relates to a system and method for manufacturing a semiconductor device, and more particularly, to a system and method for performing a photolithography process.

In general, a semiconductor device is manufactured by various processes such as cleaning, deposition, photolithography, etching, and ion injection. A photolithography process forming a pattern plays an important role in achieving high integration of a semiconductor device.

In general, a system for performing a photolithography process includes a coating unit, an exposure unit, a development unit, and a plurality of bake units. The exposure unit emits light onto a photoresist coated on a wafer to change a property of the photoresist for each wafer region. An i-line had been used as a conventional light source, but recently a deep ultraviolet light source has been used because of a decrease in design rule. When the deep ultraviolet light source is used, a post-exposure bake process is necessarily required. In the post-exposure bake process, the wafer is heated to catalyze acid generated in the photoresist by the exposure, thereby completing the property change of the photoresist.

A post-exposure bake process is started after the exposure process. A heating temperature and a heating time are important factors in determining a range of a property-modification region of the photoresist. If the light-exposed wafer is exposed to the air, patterns on the wafer are deformed by alkali components of the air. For this reason, it is very important that the post-exposure bake process must be performed on the exposed wafer within a predetermined time, generally within only a few minutes. FIG. 1 shows a comparison between a wafer on which a post-exposure bake process is performed within a desired time, and a wafer exposed to the air for a long time after light exposure. Degradation of the wafer patterns is noticeable in the wafer that is exposed to air for an extended time prior to post-exposure baking.

In a general photolithography system, an application and development module, including the coating unit, the development unit, and the bake units, and an exposure module including the exposure unit, are connected in-line by an interface module. Communication is made between a first controller to control the application and development module, and a second controller to control the exposure module.

The application and development module is frequently stopped whenever a hardware error, a software bug, or an unaccounted-for error occurs in any of the components of the processing system, including the robotic assembly, the coating unit, the development unit, and the bake units of the application and development module. In this case, wafers exposed at the exposure unit are not timely transferred to the application and development module, but wait in the exposure module. Hence, the post-exposure bake process is not performed on the exposed wafers in time, exposing the wafers to the air for an extended time, and thereby causing defective patterns. Furthermore, because of this stoppage, wafers in the post-exposure bake process are continuously and excessively heated in the bake unit of the application and development module until the error is solved, thereby causing defective patterns.

Accordingly, the need remains for methods within a photolithography system that addresses problems caused by stoppages from errors in the application and development module.

### SUMMARY OF THE INVENTION

The present invention provides a photolithography system and method capable of efficiently performing a photolithography process.

The present invention also provides a photolithography system and method capable of performing a post-exposure bake process on an exposed wafer in time even when an error occurs at an application and development module.

The present invention is not limited to the above description, and other objects of the present invention will be clearly understood from the following description by those skilled in the art.

In an embodiment, a photolithography method comprises: performing, at a bake unit of an application and development module, a bake process on a substrate exposed by an exposure unit when the application and development module is operating without an error; and performing, at a bake unit of an interface module, a bake process on the substrate exposed by the exposure unit when an error occurs at the application and development module, wherein the application and development module includes a coating unit and a development unit, wherein an exposure module includes the exposure unit, and wherein the interface module is located between the application and development module and the exposure module.

The interface module may include a buffer unit for storing the substrate that is baked at the bake unit of the interface module.

The exposure unit may be configured to perform an exposure process using a DUV (deep ultraviolet) light source, and the bake unit of the interface module is configured to perform a PEB (post-exposure bake) process.

In another embodiment, the method may also comprise: moving the substrate baked at the bake unit of the application and development module to a buffer unit that is included in the application and development module when the error occurs at the application and development module and storing the moved substrate in the buffer unit.

In still another embodiment, a photolithography method uses a photolithography system including an application and development module that includes a coating unit, a development unit and a plurality of bake units; an exposure module that includes an exposure unit; and an interface module that includes a bake unit and is located between the application and development module and the exposure module. The method comprises: when the application and development module is operating without an error, transferring a substrate processed at the exposure module to the application and development module by communication between a coating and development module controller and an exposure module controller, and performing a bake process on the substrate at the bake unit of the application and development module. When the application and development module is operating with an error, however, the method proceeds by performing a bake process on the exposed substrate at the bake unit of the interface module. Communication between an auxiliary controller is configured to control the bake unit of the interface module and the exposure module controller.

In yet another embodiment, a photolithography system comprises: an application and development module including a coating unit, a development unit, and a plurality of bake units; an exposure module including an exposure unit; an interface module including a bake unit and an interface robot, the interface module disposed between the application and development module and the exposure module; a coating and development module controller; an exposure module controller for controlling the exposure module and the interface robot, and for communicating with the coating and development module controller when the application and development module is operating without error; and an auxiliary controller for controlling the bake unit of the interface module, and for communicating with the exposure controller when an error occurs at the application and development module.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 illustrates a wafer on which a post-exposure bake process is performed in time, and wafers on which a bake process is performed after different long-time exposures to the air;

FIG. 2 is a schematic plan view of a photolithography system according to an embodiment of the present invention;

FIG. 3 is a schematic perspective view of an internal structure of an application and development module and an interface module of the photolithography system of FIG. 2;

FIG. 4 is a schematic perspective view of a modified example of the photolithography system of FIG. 2;

FIG. 5 is a plan view of a control unit of the photolithography system of FIG. 2 according to an embodiment of the present invention; and

FIGS. 6 through 8 are views of photolithography systems to illustrate methods of performing a process in the system of FIG. 5 according to an embodiment of the present invention.

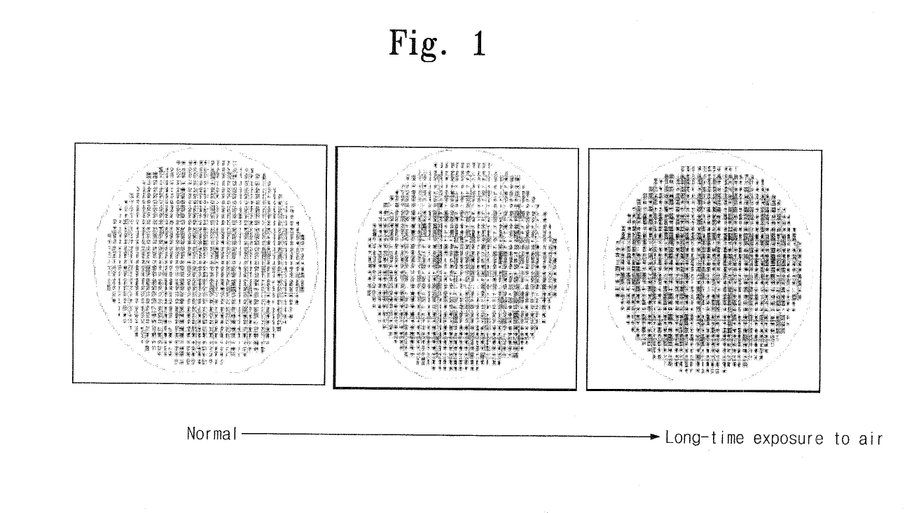

### DETAILED DESCRIPTION OF PREFERRED EMBODIMENTS

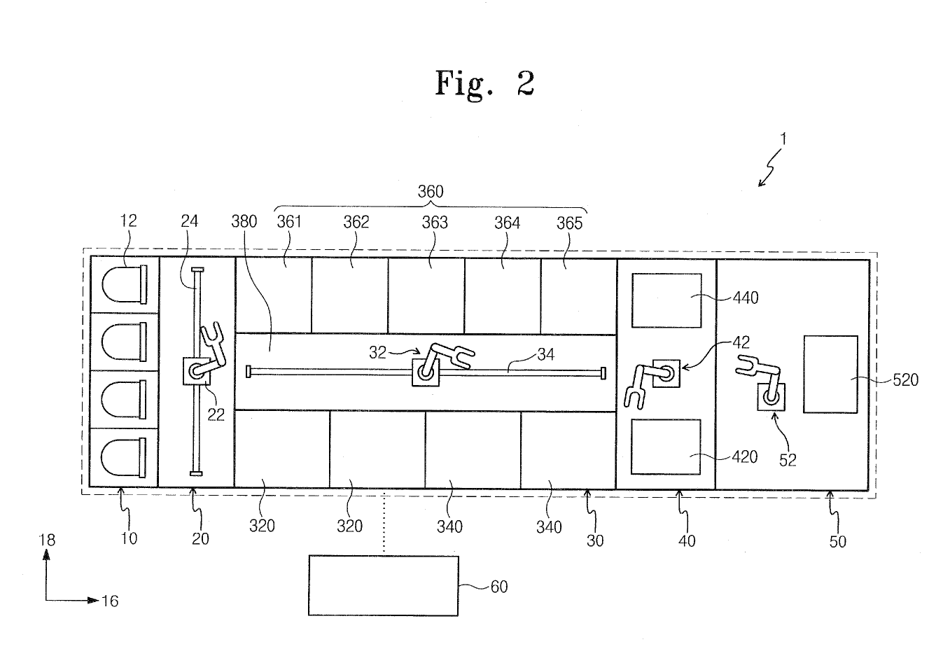

Preferred embodiments of the present invention will be described below in more detail with reference to FIGS. 2 through 8. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the figures, the dimensions of layers and regions may be exaggerated for clarity of illustration.

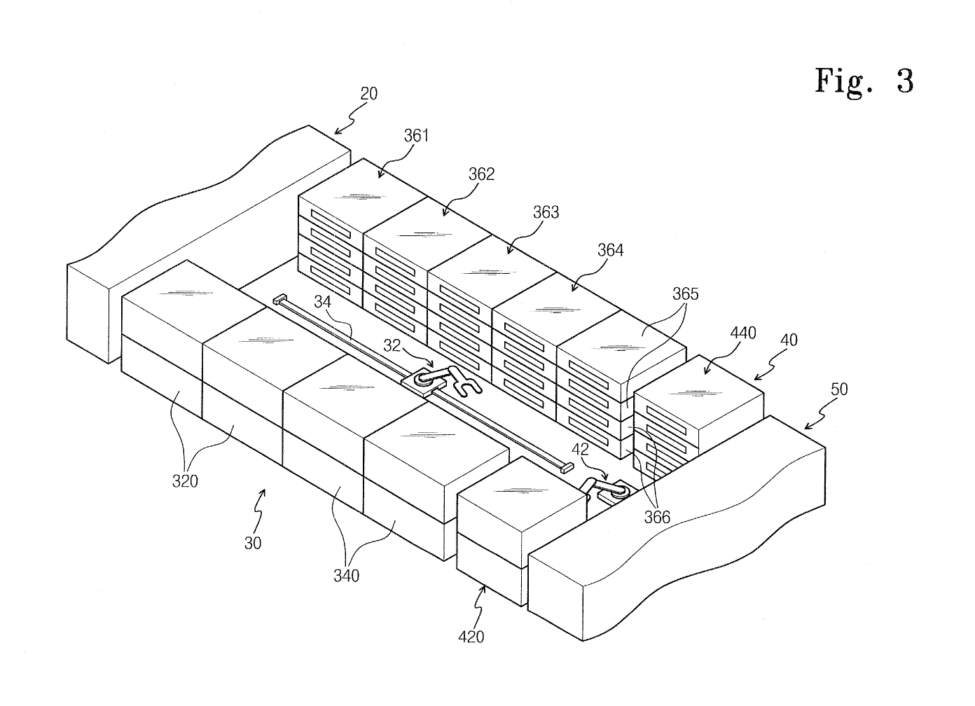

FIG. 2 is a schematic plan view illustrating a structure of a photolithography system 1 according to an embodiment of the present invention. FIG. 3 is a schematic perspective view illustrating an internal structure of an application and development module 30 and an interface module 40. In FIG. 3, a partition wall provided between the application and development module 30 and the interface module 40 is omitted.

Referring to FIGS. 2 and 3, the photolithography system 1 includes a load port 10, an index module 20, an application and development module 30, an interface module 40, an exposure module 50, and a control unit 60. The load part 10, the index module 20, the application and development module 30, the interface module 40, and the exposure module 50 are sequentially disposed in a row in a first direction 16, and are connected in-line. A container 12 for receiving wafers is placed in the load port 10. A plurality of load ports 10 is provided, and the load ports 10 are disposed side by side along one side surface of the index module 20 in a second direction 18 that is perpendicular to the first direction 16. The application and development module 30 includes a coating unit 320 for performing an application process on a wafer, a development unit 340 for performing a development process, and a plurality of bake units 360 for performing a heating or cooling process. The exposure module 50 includes an exposure unit 520 for performing an exposure process.

The index module 20 is disposed between the load port 10 and the application and development module 30. The index module 20 includes an index robot 22 for transferring a wafer between the container 12 and the application and development module 30, and a guide rail 24 for guiding a movement of the index robot 22 so that the index robot 22 linearly moves in the second direction 18.

A wafer passage 380 may be disposed in the center of the application and development module 30. The wafer passage 380 is provided from a region adjacent to the index module 20 up to a region adjacent to the interface module 40. The application and development module 30 includes a plurality of process units installed at both sides of the wafer passage 380 along the wafer passage 380.

The bake units 360 heat and cool a wafer before or after it is transferred to the coating unit 320, the exposure unit 520, and the developer unit 340. The bake units 360 include a bake unit 361 for performing a pre-baking process of heating the wafer to a predetermined temperature to remove an organic material or moisture from a surface of the wafer before a photoresist is applied, a bake unit 362 for performing a soft baking process after the photoresist is applied onto the wafer, a bake unit 363 for performing a hard baking process performed after the photoresist modified by light radiation is developed, a bake unit 364 for performing a post-exposure baking process after the photoresist is exposed to light, and a bake unit 365 for performing a process of cooling the wafer.

According to one example, the coating units 320 and the development units 340 are provided at one side of the wafer passage 380, and the bake units 360 are provided at the other side of the wafer passage 380. The plurality of process units may also be stacked. The numbers and dispositions of the coating unit 320, the development unit 340, and the bake units 360 of the application and development module 30 may vary without being limited to those shown in FIG. 2.

The application and development module 30 includes a buffer unit 366 (FIG. 3). The buffer unit 366 is constructed to temporarily store a wafer-in-process in the bake unit 360 when an error occurs in the application and development module 30. It is desirable that the wafer-in-process at the bake unit 360 is transferred to the buffer unit 366 after the process is completed.

According to one embodiment, the buffer unit 366 may have a structure (not shown) that includes a plate on which the wafer is placed. In this case, one or more buffer units 366 may be provided. Otherwise, the buffer unit 366 may have structures (not shown) stacked on top of one another and each including slots that support the edges of a wafer. Since the buffer unit 366 having such structures can support a plurality of wafers, the application and development module 30 may include just one buffer unit 366. The buffer unit 366 may be stacked with the bake unit 360.

A process robot 32 and a guide rail 34 are provided in the wafer passage 380. The process robot 32 is configured to transfer a wafer between the index module 20 and the application and development module 30, between the interface module 40 and the application and development module 30, and between the process units within the application and development module 30. The guide rail 34 is linearly disposed within the wafer passage 380 and guides the movement of the process robot 32 linearly in the first direction 16. The process robot 32, the index robot 22, and an interface robot 42 to be described later may be configured to directly exchange a wafer between the process robot 32 and the index robot 22, and between the process robot 32 and the interface robot 42, or may be configured to exchange the wafer using a stage (not shown) on which the wafer is placed.

The exposure module 50 includes an exposure unit 520 for emitting light onto a photoresist formed on the wafer, using a mask having a pattern. In the present embodiment, the exposure unit 520 may use a deep ultraviolet ray (DUV). For example, a KrF excimer laser or an ArF excimer laser may be used as a light source. The exposure module 50 includes a process robot 52 for transferring a wafer between the interface module 40 and the exposure unit 520.

The interface module 40 is disposed between the application and development module 30 and the exposure module 50. The interface module 40 includes an interface robot 42 for transferring a wafer between the application and development module 30 and the exposure module 50. Also, the interface module 40 includes a bake unit 420 and a buffer unit 440. The bake unit 420 is constructed to perform a baking process right after the exposure process on the exposed wafer. For example, if the exposure process is performed using a DUV light source as mentioned above, then the bake unit 420 installed in the interface module 40 is constructed to perform a post-exposure bake (PEB) process.

The buffer unit 440 is configured to temporarily store in the bake unit 420 of the interface module 40 a wafer that was processed in the bake unit 360 of the application and development module 30. The buffer unit 440 may have an identical or similar structure as the buffer unit 366 provided in the application and development module 30.

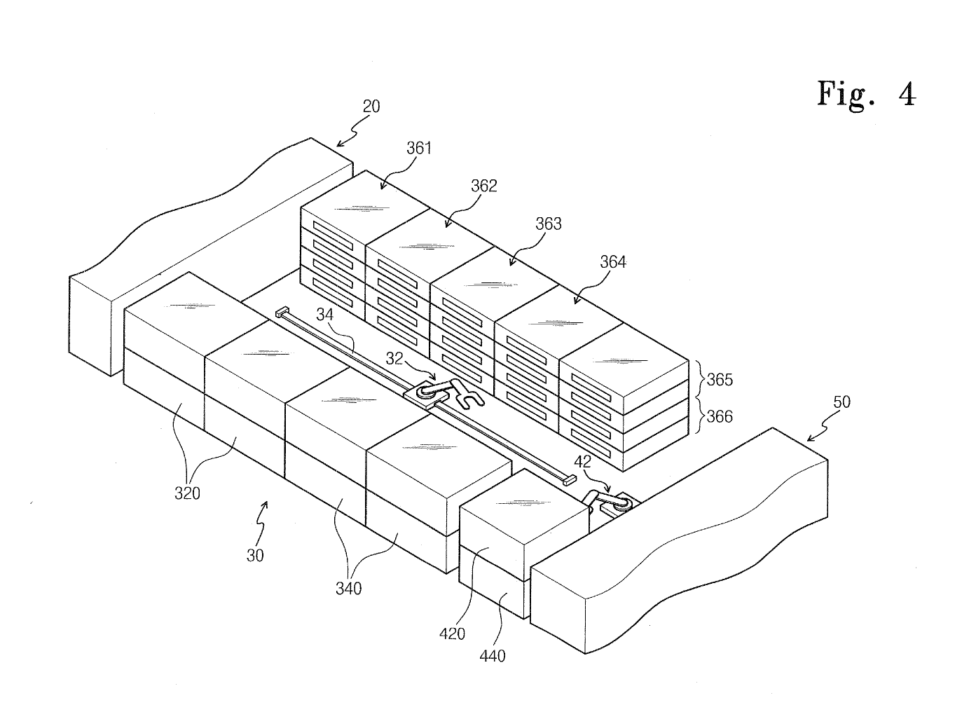

As illustrated in FIGS. 2 and 3, the buffer unit 440 and the bake unit 420 may be disposed to face each other, with the interface robot 42 therebetween. The interface module 40 may include one or more bake units 420 performing the same process and stacked together. As illustrated in FIG. 4, the bake unit 420 and the buffer unit 440 may be selectively disposed in a stack structure at one side of the interface robot 42.

The control unit 60 controls a wafer's path, the coating unit 320, the development unit 340, the bake units 360, and the exposure unit 520. Specifically, the control unit 60 controls operations of the index robot 22 of the index module 20, the process robot 32 of the application and development module 30, the interface robot 42 of the interface module 40, and the process robot 52 of the exposure module 50. Also, the control unit 60 controls components of the coating unit 320, the development unit 340, the bake units 360 and the exposure unit 520 so that processes are performed according to preset process conditions. For example, the amount of a coating liquid or a developer liquid sprayed onto a wafer, a spray temperature, and a spray time may be preset process conditions in regard to the coating unit 320 or the development unit 340, as well as heating and cooling temperatures and times in regard to the bake units 360.

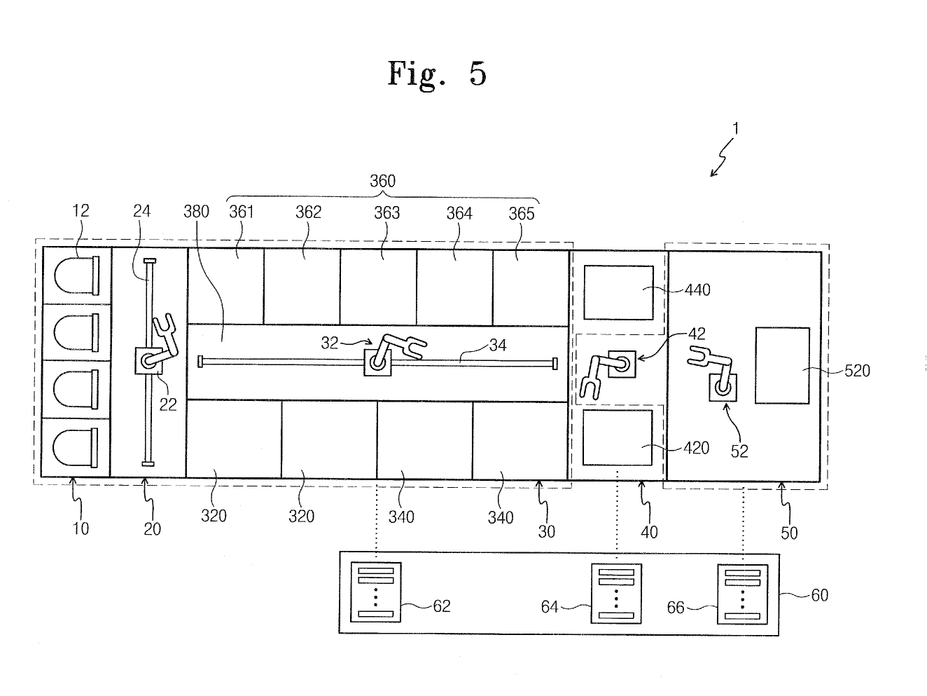

FIG. 5 illustrates the control unit 60 of FIG. 2 according to an embodiment of the present invention. The bake units 365 and 420 for performing the post-exposure bake process are installed in the application and development module 30 and the interface module 40, respectively. The control unit 60 includes a coating and development module for controlling the coating unit 320, the development unit 340, the bake units 360 and the process robot 32 of the application and development module 30, an exposure controller 66 for controlling the exposure unit 520 and the process robot 52 of the exposure module 50, the interface robot 42 of the interface module 40, and an auxiliary controller 64 for controlling the bake unit 420 of the interface module 40. The index robot 22 of the index module 20 may also be controlled by the application and development controller 62.

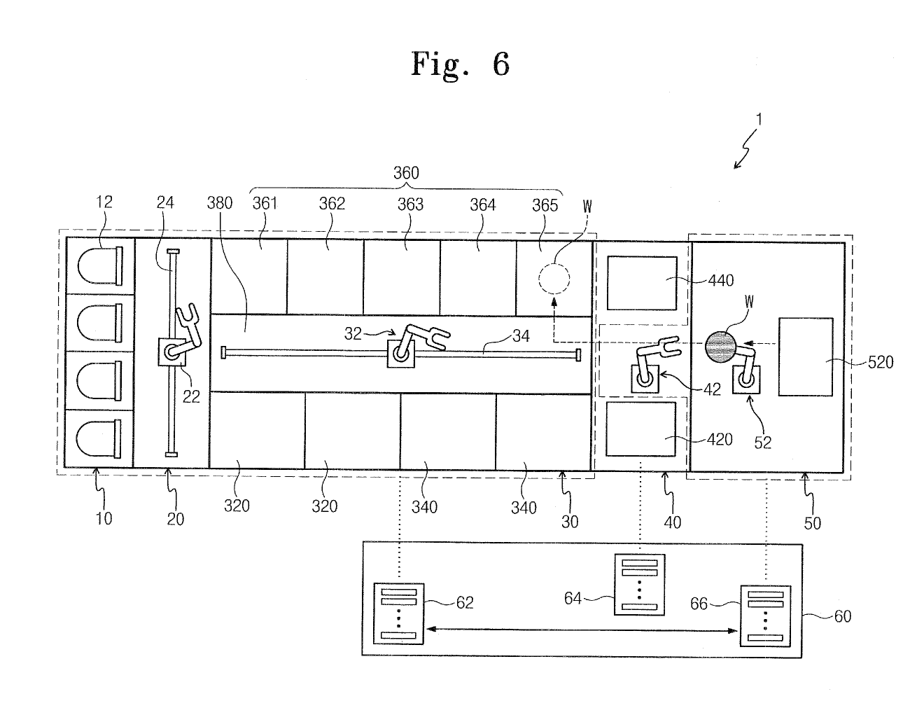

FIGS. 6 through 8 illustrate a wafer path of a wafer (W) when the control unit 60 of FIG. 6 is used. In FIGS. 6 through 8, dashed arrows indicate a path of the wafer (W).

Referring to FIGS. 6 through 8, when a process is normally performed in the application and development module 30, communication is made between the application and development controller 62 and the exposure controller 66 as shown by the solid line double-arrow between the two controllers. The exposed wafer (W) is transferred to the bake unit 365 of the application and development module 30 so that the wafer can be subjected to a post-exposure bake process.

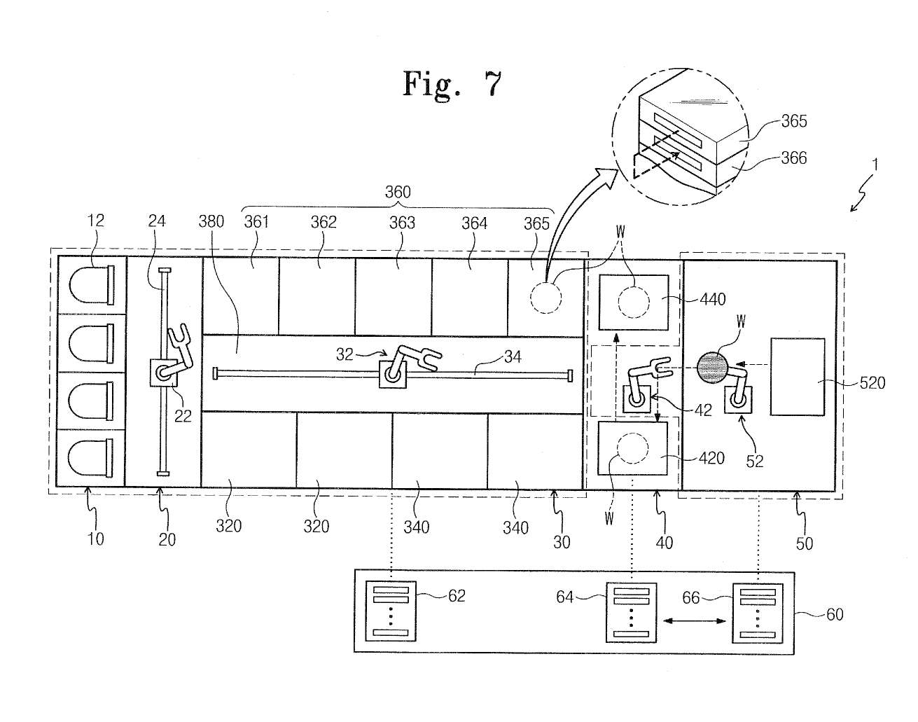

Referring to FIG. 7, the wafer (W) stops moving when an error occurs to stop the application and development module 30. To continue the ongoing process on the exposed wafer (W), communication between the exposure controller 66 and the auxiliary controller 64 is made, shown again by the solid line double-arrow of FIG. 7. The exposed wafer (W) may then be transferred to the bake unit 420 of the interface module 40, to undergo a post-exposure bake process in the bake unit 42. Thereafter, the wafer (W) is moved to the buffer unit 440 of the interface module 40 where it is stored.

Wafers (W) moved to the exposure module 50 before the error occurs in the application and development module 30 may be continuously processed in the exposure unit 520. The exposed wafers (W) undergo a post-exposure bake process in the bake unit 420 of the interface module 40, and then are stored in the buffer unit 440.

Also, if no error occurs in the process robot 32 within the application and development module 30, the application and development controller 62 controls the bake unit 365 to continuously perform an ongoing post-exposure bake process on a corresponding wafer (W) in the bake unit 365 of the application and development module 30. Thereafter, when the post-exposure bake process is completed in the bake unit 365, the process robot 32 of the application and development unit 34 transfers the baked wafer (W) to the buffer unit 366 of the application and development unit 340. The wafer (W) may be stored in the buffer unit 366 until the error is corrected.

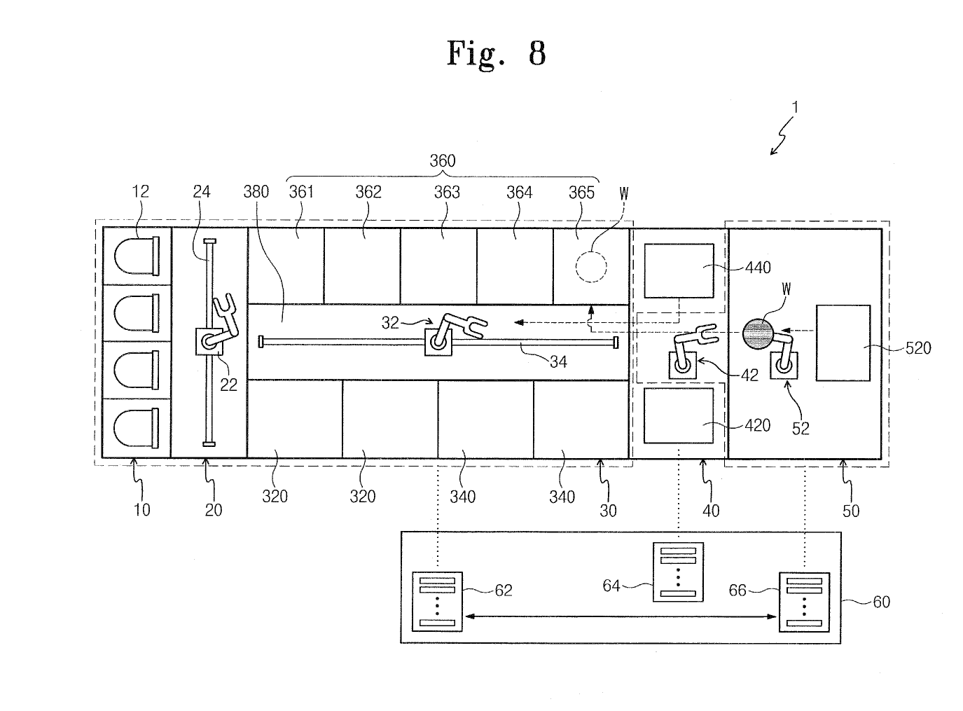

Referring to FIG. 8, when the error is corrected in the application and development module 30, communication between the application and development controller 62 and the exposure controller 66 may be started so that information on a wafer state within each of the modules 30, 40 and 50 is exchanged therebetween. Wafers (W) stored in the buffer unit 440 of the interface module 40 may be moved to the application and development module 30, and the next process may be continuously performed on the wafers (W). Then, the communication between the exposure controller 66 and the auxiliary controller 64 may be stopped, and a post-exposure bake process is performed on the exposed wafer (W) in the bake unit 360 of the application and development module 30, as normally occurs.

According to the above embodiment, the bake unit 420 for performing a post-exposure bake process in the interface module 40, and the auxiliary controller 64 for controlling the bake unit 420 are further provided to the existing system 1 in which the application and development module 30 and the exposure module 50 are connected in-line to perform a process. Hence, even if an error occurs in the application and development module 30, the post-exposure bake process can be performed on an exposed wafer within a desired time.

The application and development module 30 includes the buffer unit 366, so that even if an error occurs in the application and development module 30, a wafer can be prevented from undergoing a post-exposure process in the bake unit 365 of the application and development module 30 after a preset time elapses.

In the above embodiment, the exposure controller 66 is configured to control the interface robot 42 of the interface module 40, and the auxiliary controller 64 may communicate with the exposure controller 66 only when an error occurs at the application and development module 30. However, the interface robot 42 and the bake unit 420 of the interface module 40 may be controlled by the auxiliary controller 64, and communication between the auxiliary controller 64 and the exposure controller 66, and between the auxiliary controller 64 and the development controller 62 may be continuously made during a process.

In the above embodiment, the exposure unit 520 performs an exposure process using a deep ultraviolet light source, and the bake unit 420 of the interface module 40 performs a post-exposure bake process. However, the exposure unit 520 may perform the exposure process using a light source such as an i-line, instead of the deep ultraviolet light source, and the interface module 40 may include a bake unit that performs a baking process besides the post-exposure bake process.

According to the present invention, even when an error occurs at the application and development module, a post-exposure bake process can be performed on a wafer exposed using a deep ultraviolet light source. Thus, a defective pattern can be prevented from occurring due to long-time exposure of the exposed wafer to the air.

Also, according to the present invention, the application and development module includes a buffer unit, so that even if an error occurs in the application and development module, a wafer in a post-exposure bake process can be performed within a preset process time, and the wafer can be stored in the buffer unit. Thus, a defective pattern is prevented.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A photolithography method comprising:
detecting whether or not an error occurs in an application and development module of a photolithography system; and
in case the error is detected, moving an exposed substrate from an exposure unit within the photolithography system to an interface module interposed between the application development module and the exposure unit for a bake process,
otherwise, moving the exposed substrate from the exposure unit to the application and development module for a bake process at a bake unit.

2. The method of claim 1, further including the steps of:
performing, at a bake unit of the interface module, a bake process on the substrate to form a baked substrate; and
storing the baked substrate within a buffer unit at the interface module.

3. The method of claim 1, wherein the exposure unit is configured to perform an exposure process using a deep ultraviolet (DUV) light source, and the bake unit of the interface module is configured to perform a post-exposure bake (PEB) process.

4. The method of claim 1, further comprising:
moving the substrate baked at the bake unit of the application and development module to a buffer unit that is included in the application and development module when the error occurs at the application and development module; and
storing the moved substrate in the buffer unit.

5. A photolithography method using a photolithography system including an application and development module that includes a coating unit, a development unit and a plurality of bake units; an exposure module that includes an exposure unit; and an interface module that includes a bake unit and is located between the application and development module and the exposure module, the method comprising:
monitoring whether or not the application and development module is operating with an error;
when the application and development module is operating without the error,
transferring a substrate processed at the exposure module to the application and development module by communication between a coating and development module controller and an exposure module controller, and
performing, a bake process on the substrate at the bake unit of the application and development module; and
when the application and development module is operating with the error,
transferring the substrate processed at the exposure module to the interface module, and
performing a bake process on the substrate processed at the exposure module at the bake unit of the interface module by communication between an auxiliary controller configured to control the bake unit of the interface module and the exposure module controller.

6. The method of claim 5, wherein the exposure unit is configured to perform an exposure process using a deep ultraviolet (DUV) light source, and the bake unit of the interface module is configured to perform a post-exposure bake (PEB) process.

7. The method of claim 5, wherein the interface module further includes a buffer unit for storing the substrate that is baked at the bake unit of the interface module.

8. The method of claim 7, further including the steps of:
monitoring a correction of the error of the application and development module; and
responsive to the monitoring step, transferring the substrate stored in the buffer unit of the interface module to the application and development module to be continuously processed.

9. The method of claim 5, further comprising:
moving the substrate baked at the bake unit of the application and development module to a buffer unit that is included in the application and development module when the error occurs at the application and development module; and
storing the moved substrate in the buffer unit.

10. A photolithography system comprising:
an application and development module including a coating unit, a development unit, and a plurality of bake units;
an exposure module including an exposure unit;
an interface module including a bake unit and an interface robot the interface module disposed between the application and development module and the exposure module;
a coating and development module controller;
means for monitoring whether or not an error occurs at the application and development module;
an exposure module controller for controlling the exposure module and the interface robot, and for communicating with the coating and development module controller when the application and development module is operating without the error; and
an auxiliary controller for controlling the bake unit of the interface module, and for communicating with the exposure controller when the application and development module operates with the error.

11. The system of claim 10, wherein the interface module further includes a buffer unit for storing a substrate baked at the bake unit of the interface module.

12. The system of claim 10, wherein the exposure unit is constructed to perform an exposure process on a substrate including a photoresist applied thereon, using a deep ultraviolet (DUV) light source, and
the bake unit of the interface module is constructed to perform a post-exposure bake (PEB) process.

13. The system of claim 10, wherein the bake units of the application and development module include a bake unit for performing a post-exposure bake (PEB) process.

14. The system of claim 11, wherein the application and development module further includes a buffer unit for storing a substrate baked at the application and development module.

15. The system of claim 11, wherein the interface robot is disposed between the bake unit and the buffer unit of the interface module.

16. The system of claim 1, wherein the bake unit and buffer unit of the interface module are selectively disposed in a stake structure at one side of the interface robot.
